(19) United States
(12) Patent Application Publication
(10) Pub. No.: US 2008/0019518 A1
(43) Pub. Date: Jan. 24, 2008

(54) SEMICONDUCTOR MEMORY AND DATA TRANSFER SYSTEM

(75) Inventor: Kumiko MITO, Osaka (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MegaChips Corporation, Osaka-shi (JP)

(21) Appl. No.: 11/761,765

(22) Filed: Jun. 12, 2007

(30) Foreign Application Priority Data
Jun. 27, 2006 (JP) 2006-176281

(51) Int. Cl. H04N 7/167

(52) U.S. Cl. 380/217

(57) ABSTRACT

A semiconductor memory includes a memory array and a scramble/descramble unit. The scramble/descramble unit scrambles read data read from the memory array to generate output data, and descrambles a received scrambled signal to generate a command for the memory array. The scramble/descramble unit updates a method of generating keys used for scrambling/descrambling when one selected between at least two out of the scrambled signal, the command, the read data, and the output data satisfies prescribed conditions, respectively.

### BACKGROUND OF THE INVENTION

1. Field of the Invention

The present invention relates to techniques of scrambling data.

2. Description of the Background Art

It has been proposed to scramble data transferred between a host device and a semiconductor memory removably connected thereto. This is to avoid illegal acquisition of information stored in the semiconductor memory by observation of signals at a connection portion with the host device.

Techniques of generating with a shift register a data sequence (hereafter called the scrambling key) used for scrambling by performing logical operations with a given number of data streams are disclosed in Japanese Patent Application Laid-Open Nos. 2000-278099, 2002-150698, 2002-170333, and 10-308720 (1998), for example.

To improve confidentiality of data by scrambling, it is preferable that randomness be added to the generation of scrambling keys. Such randomness is preferably added by updating processes of generating the scrambling keys with coordinated timing between the host device side and the semiconductor memory side.

Once the process has been analyzed, however, subsequent scrambling keys become predicted, causing the scrambling of data obtained from the semiconductor memory to be cracked.

Another method of adding randomness to the update is to randomize a value (e.g. initial value) used for updating the process of generating the scrambling keys. But if the process is updated with timing simply based on a timer at fixed periods, the advantage of randomizing the initial value will be spoiled by forcefully stopping the timer.

### SUMMARY OF THE INVENTION

It is therefore an object of the present invention to improve the efficiency of randomness of updating a method of generating scrambling keys by preparing a plurality of criteria for determining the timing of updating the method. Such randomness is achieved by randomizing the initial value, for one example, or by changing a method used for generating the scrambling keys, for another example.

A semiconductor memory according to the present invention includes a memory array and a scramble/descramble unit. In a first aspect of the invention, the scramble/descramble unit generates output data by scrambling read data read from the memory array, generates a command for the memory array by descrambling a received scrambled signal, and updates a method of generating a key used for the scrambling and/or descrambling upon satisfaction of a prescribed condition by at least one selected between at least two out of the scrambled signal, the command, the read data, and the output data.

In a third aspect of the invention, the scramble/descramble unit generates output data by scrambling read data read from the memory array, generates a command for the memory array by descrambling a received scrambled signal, and updates a method of generating a key used for the scrambling and/or descrambling upon satisfaction of a prescribed condition by at least one selected between the scrambled signal and the output data.

In a second aspect of the semiconductor memory according to the invention, in the first aspect, the scramble/descramble unit includes a control circuit generating a control signal for updating the method of generating the key, and a selector supplying the read data and the scrambled signal selectively to the control circuit.

In a fourth aspect of the semiconductor memory according to the invention, in the third aspect, the scramble/descramble unit includes a control circuit, the control circuit receiving the scrambled signal and the output data and generating a control signal for updating the method of generating the key upon satisfaction of the prescribed condition by at least one of the scrambled signal and the output data.

In a fifth aspect of the semiconductor memory according to the invention, in the second or fourth aspect, the scramble/descramble unit includes an operation unit calculating an exclusive OR of the scrambled signal or the read data and the key.

A data transfer system according to the invention includes: the semiconductor memory according to the invention; and a host device, the host device including a scramble/descramble unit scrambling and/or descrambling using the key.

By way of example, the key is a maximum length sequence pseudorandom number or Gold sequence pseudorandom number. By way of example, the update is to update an initial value of the pseudorandom number, update a characteristic equation of the pseudorandom number, or update of the number of shift bits of the pseudorandom number.

According to the first aspect of the semiconductor memory of the invention, the preparation of a plurality of criteria for determining the timing of updating the method of generating the keys improves the efficiency of randomness of updating the method.

According to the second to fourth aspects of the semiconductor memory of the invention, the read data or scrambled signal may be selected as a criterion for determining the timing of updating the method of generating the keys.

According to the fifth aspect of the semiconductor memory of the invention, the same keys can be used both for scrambling processing and descrambling processing.

According to the data transfer system of the invention, information transferred between the host device and the semiconductor memory is scrambled, thereby avoiding illegal acquisition of the information.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram of the structure of a data transfer system employing an exemplary scramble/descramble technique according to the present invention;

FIG. 2 is a block diagram indicating a first function;

FIG. 3 is a block diagram indicating a second function;

FIG. 4 is a block diagram showing flows of four elements supplied to a shift register control circuit.

FIG. 5 is a circuit diagram of the structure of a key generation unit according to a first preferred embodiment of the invention;

FIG. 6 is a circuit diagram showing the structures of and the connection relationship between a group of shit registers and an operation unit according to the first preferred embodiment;

FIG. 7 is a circuit diagram of the structure of the key generation unit according to a second preferred embodiment of the invention;

FIG. 8 is a circuit diagram of the structure of the key generation unit according to a third preferred embodiment of the invention;

FIG. 9 is a circuit diagram of the structure of the key generation unit according to a fourth preferred embodiment of the invention;

FIG. 10 is a circuit diagram of the structure of the key generation unit according to a fifth preferred embodiment of the invention;

FIG. 11 is a circuit diagram of the structure of a feedback circuit according to the fifth preferred embodiment;

FIG. 12 is a circuit diagram of the structure of an operation circuit according to the fifth preferred embodiment;

FIG. 13 is a circuit diagram of the structure of the key generation unit according to a sixth preferred embodiment of the invention;

FIG. 14 is a circuit diagram of the structure of the feedback circuit according to the sixth preferred embodiment;

FIG. 15 is a circuit diagram of the structure of the operation circuit according to the sixth preferred embodiment; and

FIG. 16 is a circuit diagram of the structure of a composition unit according to the sixth preferred embodiment.

### DESCRIPTION OF THE PREFERRED EMBODIMENTS

[Basic Concept]

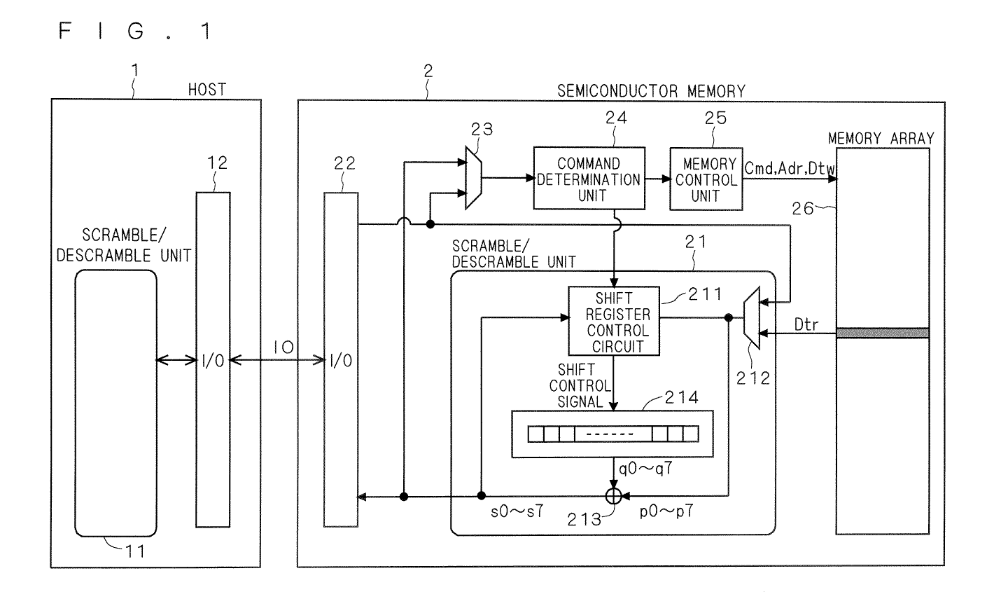

FIG. 1 is a schematic block diagram of the structure of a data transfer system employing an exemplary scramble/descramble technique according to the present invention. The system includes a host device 1 and a semiconductor memory 2, and a scrambled signal IO is transferred between them.

By way of example, 8-bit parallel data is used and exclusive ORs of the 8-bit parallel data and 8-bit scrambling keys are calculated by scrambling/descrambling in this embodiment. It should be understood that this is an exemplary embodiment and should not be construed as limiting the scope of the present invention.

The host device 1 includes a scramble/descramble unit 11 and an input/output unit (indicated as “I/O” in the drawings) 12. In addition to performing the functions of the scramble/descramble unit 11 and I/O unit 12, the host device 1 performs a process of outputting a command Cmd, write data Dtw, and an address Adr indicative of a storage destination of the write data Dtw to the semiconductor memory 2, and a process of receiving read data Dtr from the semiconductor memory 2. These functions and processes are not directly pertinent to the present invention, and descriptions thereof are not provided.

The semiconductor memory 2 includes a scramble/descramble unit 21, an input/output unit (indicated as “I/O” in the drawings) 22, and a memory array 26. The semiconductor memory 2 has two basic functions as described below, but may have other functions as well.

First function: obtain the scrambled signal IO from the host device 1 through the I/O unit 22. Descramble the scrambled signal IO to obtain the command Cmd, write data Dtw, or address Adr for the memory array 26. Input write data Dtw to the memory array 26 or read the read data Dtr from the memory array 26 based on the command Cmd, or address Adr.

Second function: scramble the read data Dtr, and output it to the host device 1 through the I/O unit 22.

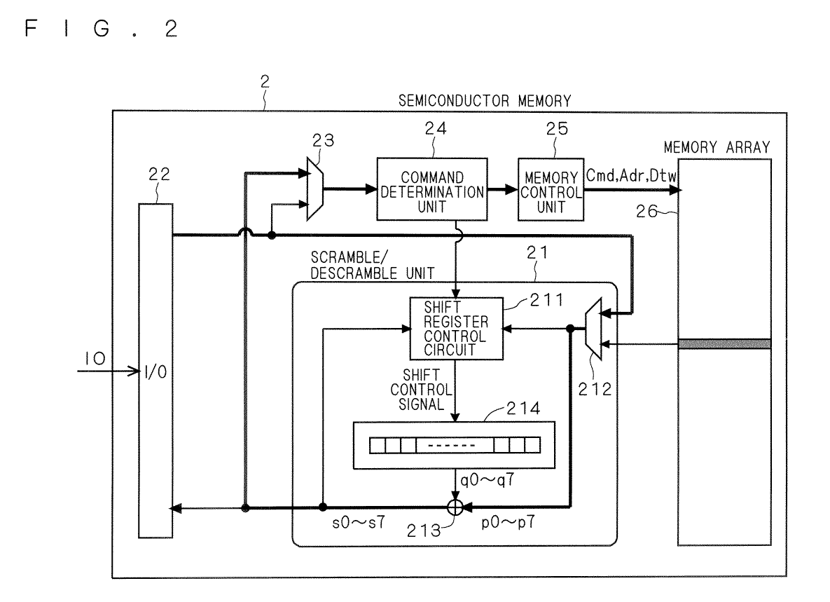

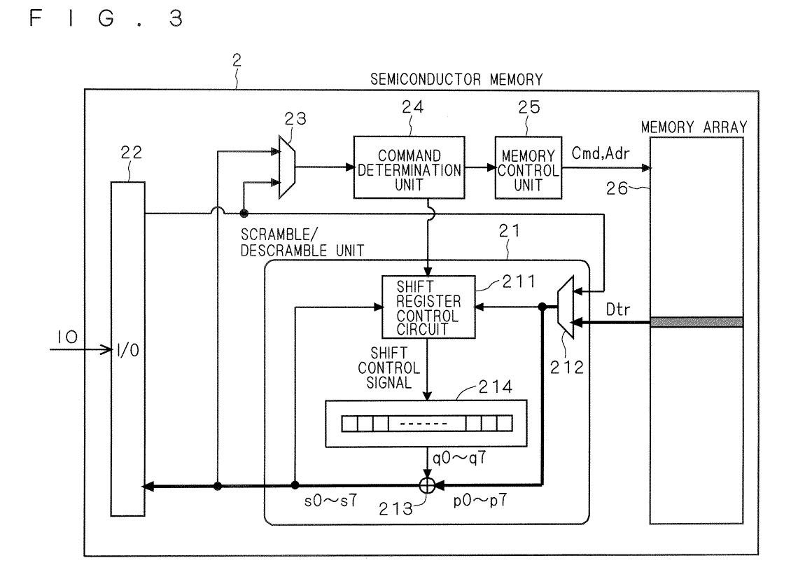

FIGS. 2 and 3 are block diagrams showing the first function and the second function, respectively. The structure itself of the semiconductor memory 2 in these drawings is the same as that shown in FIG. 1. FIGS. 2 and 3 show flows of signals and data regarding the first function and the second function, respectively, by heavy lines.

The semiconductor memory 2 also includes a command determination unit 24. The command determination unit 24 determines whether the descrambled result in the first function is the command Cmd and, if it is, supplies the command Cmd to a shift register control circuit 211 described later.

The semiconductor memory 2 further includes a memory control unit 25. The memory control unit 25 outputs the command Cmd, write data Dtw, or address Adr to the memory array 26.

The command Cmd can be a read instruction or write instruction. When it is a read instruction, the command Cmd typically involves the address Adr. Data stored in the memory array 26 at that address Adr is read as the read data Dtr based on the command Cmd. The read data Dtr is input to the scramble/descramble unit 21.

When it is a write instruction, the command Cmd typically involves the address Adr and write data Dtw. The accompanying write data Dtw is written into the memory array 26 at that address Adr based on the command Cmd.

Exceptionally, when the last command Cmd involved the address Adr, the present command Cmd may involve a difference in address value with respect to the last address Adr. Or when the last command Cmd was a write instruction involving the write data Dtw, the present command Cmd which is a write instruction may involve a difference in value with respect to the last write data Dtw.

The scramble/descramble unit 21 includes the shift register control circuit 211, a selector 212, an operation unit 213, and a key generation unit 214. The key generation unit 214 includes a group of shift registers (which is schematically illustrated as an arrangement of boxes in the drawings) that generates scrambling keys (hereafter simply called keys) q0 to q7 for scrambling/descrambling.

The selector 212 receives the scrambled signal IO through the I/O unit 22, and the read data Dtr. The selector 212 selects the scrambled signal IO or the read data Dtr in accordance with the first function or the second function performed by the semiconductor memory 2, respectively, and supplies the selected one as to-be-processed signals p0 to p7 to the operation unit 213 and the shift register control circuit 211.

The operation unit 213 receives the keys q0 to q7 and the to-be-processed signals p0 to p7. When the semiconductor memory 2 performs the first function, the to-be-processed signals p0 to p7 are to be descrambled, and output data s0 to s7 from the operation unit 213 is descrambled command Cmd, write data Dtw, or address Adr. When the semiconductor memory 2 performs the second function, the to-be-processed signals p0 to p7 are to be scrambled, and the output data s0 to s7 from the operation unit 213 is obtained by scrambling the read data Dtr, to be supplied to the I/O unit 22 and the shift register control circuit 211. The operation unit 213 process 8 bits in parallel, and calculates an exclusive OR for each bit of the keys q0 to q7 and the to-be-processed signals p0 to p7.

Because the operation unit 213 calculates the exclusive ORs using the keys q0 to q7 as described above, the same keys q0 to q7 can be used both for scrambling processing and descrambling processing.

When the semiconductor memory 2 performs the second function, the output data s0 to s7 is supplied to the host device 1 though the I/O unit 22.

A method of generating the keys q0 to q7 at the key generation unit 214 is updated by a shift control signal generated by the shift register control circuit 211. The shift control signal is activated when at least one selected between at least two out of four elements supplied to the shift register control circuit 211 satisfies a prescribed condition. The four elements are (i) the scrambled signal IO obtained from the host device 1 through the I/O unit 22 and the selector 212, (ii) the command Cmd obtained from the command determination unit 24 after being descrambled, (iii) the read data Dtr obtained from the memory array 26 through the selector 212, and (iv) the output data s0 to s7 obtained by scrambling the read data Dtr at the operation unit 213.

It is not necessary for all of the four elements to be supplied to the shift register control circuit 211. For example, the shift register control circuit 211 may receive the scrambled signal IO and the output data s0 to s7 and select at least one of them, to activate the shift control signal when the selected element satisfies a prescribed condition. The selection between the elements improves the efficiency of scrambling. The selection may be changed with time.

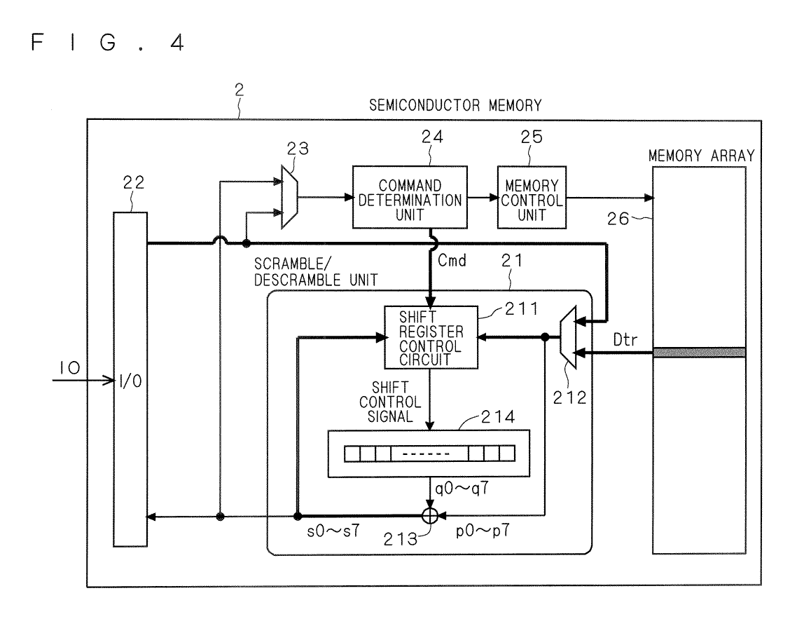

FIG. 4 is a block diagram showing flows of the four elements by heavy lines. The structure itself of the semiconductor memory 2 is the same as that shown in FIG. 1.

The four elements may be understood in combination from a different standpoint. For example, as the scrambled signal IO, the one obtained from the host device 1 (which corresponds to (i) above) and the one supplied to the host device 1 (which corresponds to (iv) above) may be understood in combination. As the read data Dtr, the one before being scrambled (which corresponds to (iii) above) and the one after being scrambled (which corresponds to (iv) above) may be understood in combination.

Since the to-be-processed signals p0 to p7, which may be the scrambled signal IO, are supplied to the shift register control circuit 211, at least the scrambled signal IO may be selected as a criterion for determining the timing of updating the method of generating the keys q0 to q7 by activating the shift control signal.

By way of example, the shift control signal is activated when the scrambled signal IO takes on a prescribed value, or when the read data Dtr takes on a prescribed value, or when the command Cmd satisfies a prescribed condition. Examples of the prescribed condition include “the command Cmd is a read instruction”, “this is the tenth command Cmd after the prescribed condition was satisfied the last time”, and the like.

Although not illustrated, the shift control signal may alternatively be activated when the descrambled information such as the write data Dtw or address Adr satisfies a prescribed condition. Examples of the prescribed condition include when the write data Dtw or address Adr takes on a prescribed value.

The shift register control circuit 211 detects the satisfaction of a prescribed condition by one of at least two out of the four elements. Such processing can be handled by software rather than by hardware. Such software may be executed by a CPU which is not illustrated but is typically provided in a semiconductor memory.

The scramble/descramble unit 11 in the host device 1 may be provided with identical structure and functions. The scramble/descramble unit 11 thus scrambles/descrambles using keys identical to the keys q0 to q7 used for scrambling/descrambling by the scramble/descramble unit 21.

It is therefore preferable that between the host device 1 and the semiconductor memory 2, the keys q0 to q7 be transferred, or information (such as the initial value described later in detail) for generating the keys q0 to q7 be transferred, or identical keys q0 to q7 be generated in synchronization with each other. For example, the keys q0 to q7 may be transferred, or non-scrambled information may be transferred for synchronized generation of the keys q0 to q7 between the host device 1 and the semiconductor memory 2. In such instances, non-scrambled information input from the I/O unit 22 needs to be supplied to the command determination unit 24.

To that end, the semiconductor memory 2 further includes a selector 23. The selector 23 selects the output data s0 to s7 when information input from the I/O unit 22 is the scrambled signal IO, or selects non-scrambled information input from the I/O unit 22, to supply either of them to the command determination unit 24.

On the occurrence of the so-called power-on reset immediately after turn-on, for example, the host device 1 transmits a command for setting the shift control signal to a default value, and the selector 23 selects the information input from the I/O unit 22 and supplies the information to the command determination unit 24. The keys q0 to q7 are thus temporarily set to default values. After that, the method of generating the keys q0 to q7 is updated with activation of the shift control signal as described above.

Except the transfer of the keys q0 to q7 and the transfer of the command for setting the shift control signal to a default value, scrambled information is transferred in principle between the host device 1 and the semiconductor memory 2. Of course the keys q0 to q7 or the initial value used for generating the keys q0 to q7 may be transferred as the scrambled signal IO, to be descrambled using the keys q0 to q7 previously used.

Moreover, part of the initial value may be preset to a default value in the host device 1 and the semiconductor memory 2 so that the remaining part is encrypted and transmitted from the host device 1 to the semiconductor memory 2. The encryption can be achieved by know encryption techniques different from the scrambling mentioned above.

The host device 1 and the semiconductor memory 2 thus form a data transfer system in which scrambled information is transferred, thereby avoiding illegal acquisition of information transferred between them.

Such preparation of a plurality of criteria for determining the timing of updating the method of generating the scrambling keys improves the efficiency of randomness of the method. Examples of the randomness will be described below.

[Randomization of Initial Value]

### First Preferred Embodiment

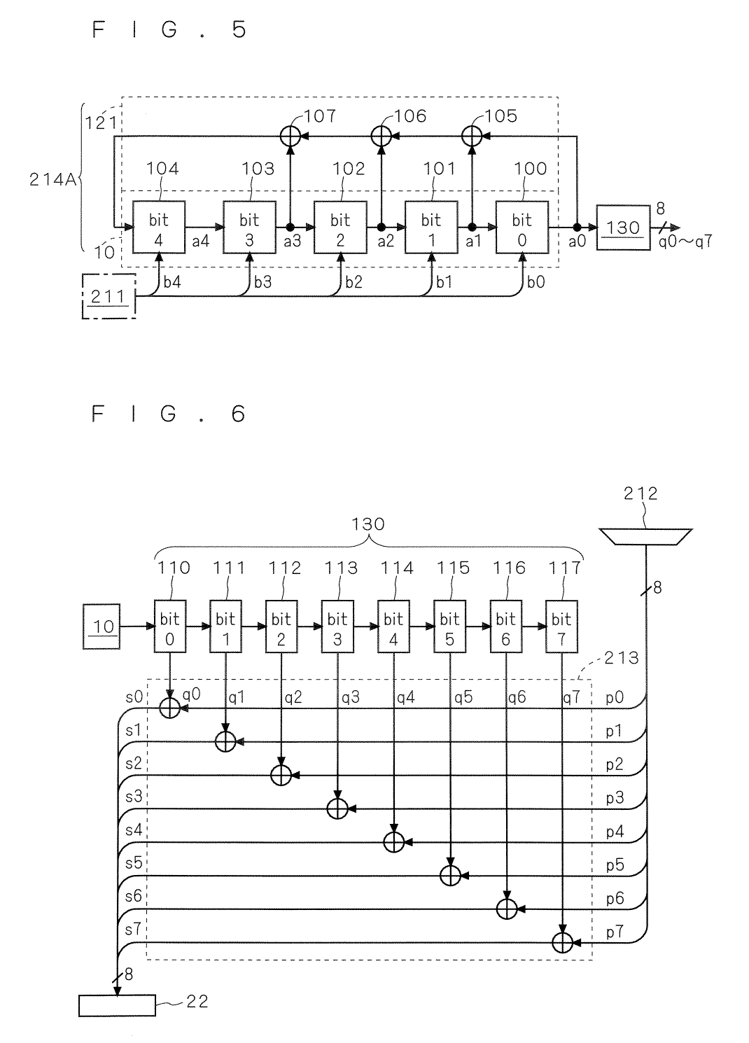

FIG. 5 is a circuit diagram of the structure of the key generation unit 214 (see FIG. 1). The key generation unit 214 includes a maximum length sequence (hereinafter stated as “M-sequence”) random number generator circuit 214A, and a group of shit registers 130 of 8 bits. The M-sequence random number generator circuit 214A includes a group of shift registers 10 of 5 bits, and a feedback circuit 121.

The group of shift registers 10 includes shift registers 100 to 104 of 1 bit connected in series that output bit values a0 to a4, respectively. The shift registers 104, 103, 102 and 101 output the bit values a4, a3, a2 and a1 to the shift registers 103, 102, 101 and 100, respectively.

The shift register 100 supplies the bit value a0 to the input side of the feedback circuit 121. The shift register 104 receives a bit value output from the feedback circuit 121.

The feedback circuit 121 includes operators 105 to 107. The operator 105 outputs an exclusive OR of the bit values a0 and a1, the operator 106 outputs an exclusive OR of the output from the operator 105 and the bit value a2, and the operator 107 outputs an exclusive OR of the output from the operator 106 and the bit value a3. The shift register 104 receives the output from the operator 107.

Thus the M-sequence random number generator circuit 214A is configured based on a characteristic equation of F(x)=x⁵+x³+x²+x+1. Although one bit is shifted at one time in the illustrated embodiment, a plurality of bits may be shifted at one time.

The shift register control circuit 211 supplies initial values b0 to b4 as an activated shift control signal to the shift registers 100 to 104, respectively. The initial values b0 to b4 may take on the value of the scrambled signal IO, for example. Of course, the initial values b0 to b4 are not given at all times but are supplied to the shift registers 100 to 104 only when the shift control signal is activated.

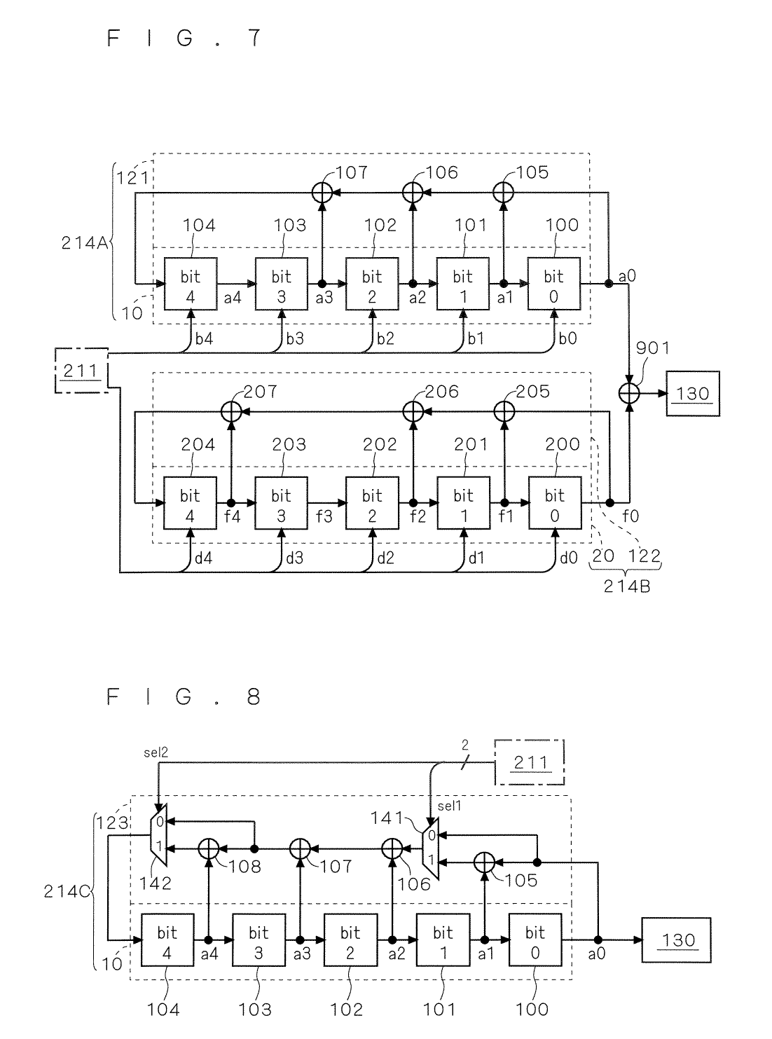

FIG. 6 is a circuit diagram showing the structures of and the connection relationship between the group of shit registers 130 and the operation unit 213. The group of shit registers 130 includes shift registers 110 to 117 of 1 bit connected in series, so that the output from the group of shift registers 10 is shifted in this order. Respective values stored in the shift registers 110 to 117 are supplied to the operation unit 213 as the keys q0 to q7, respectively.

The operation unit 213 includes eight operators, and outputs an exclusive OR of a key qi and a to-be-processed signal pi (i=0 to 7) as output data si.

In the nature of M-sequence pseudorandom numbers, with the same characteristic equation, a pseudorandom number obtained after being shifted a plurality of times can be obtained by changing the initial value. Yet when all initial values exceptionally become “0”, all the keys qi also become “0”, leaving little hope for the scrambling effect. But with new activation of the shift control signal, the initial values b0 to b4 become updated by the value of the scrambled signal IO of the moment, for example, thereby producing the scrambling effect.

The initial values b0 to b4 may of course take on values other than the value of the scrambled signal IO, such as the values of the command Cmd, address Adr, and write data Dtw, and part of the output data s0 to s7. Alternatively, the initial values b0 to b4 may be set by employing a separate mechanism that generates other pseudorandom numbers, and using those pseudorandom numbers.

### Second Preferred Embodiment

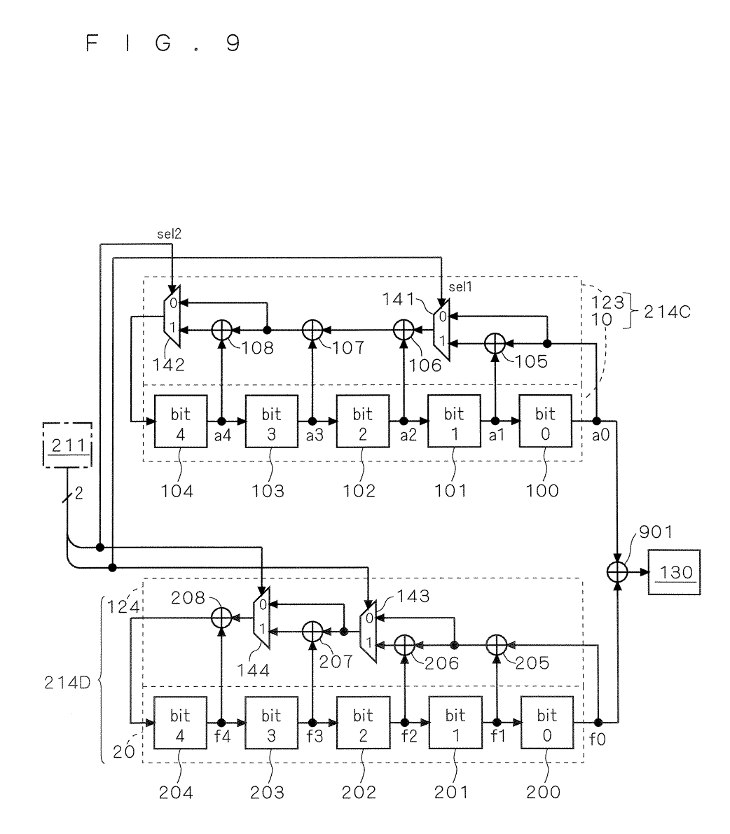

FIG. 7 is a circuit diagram of the structure of the key generation unit 214 (see FIG. 1). The key generation unit 214 includes the M-sequence random number generator circuit 214A and the group of shit registers 130 according to the first preferred embodiment, another M-sequence random number generator circuit 214B, and an operator 901.

The M-sequence random number generator circuit 214B includes a group of shift registers 20 of 5 bits and a feedback circuit 122.

The group of shift registers 20 includes shift registers 200 to 204 of 1 bit connected in series that output bit values f0 to f4, respectively. The shift registers 204, 203, 202 and 201 output the bit values f4, f3, f2 and f1 to the shift registers 203, 202, 201 and 200, respectively.

The shift register 200 supplies the bit value f0 to the input side of the feedback circuit 122. The shift register 204 receives a bit value output from the feedback circuit 122.

The feedback circuit 122 includes operators 205 to 207. The operator 205 outputs an exclusive OR of the bit values f0 and f1, the operator 206 outputs an exclusive OR of the output from the operator 205 and the bit value f2, and the operator 207 outputs an exclusive OR of the output from the operator 206 and the bit value f4. The shift register 204 receives the output from the operator 207.

Thus the M-sequence random number generator circuit 214B is configured based on a characteristic equation of F(x)=x⁵+x⁴+x²+x+1. Although one bit is shifted at one time in the illustrated embodiment, a plurality of bits may be shifted at one time.

The operator 901 produces and outputs an exclusive OR of the bit values a0 and f0 to the group of shift registers 130. Accordingly, a Gold sequence pseudorandom number is obtained from the operator 901.

The shift register control circuit 211 supplies the initial values b0 to b4 to the shift registers 100 to 104 and initial values d0 to d4 to the shift registers 200 to 204, respectively, as an activated shift control signal. The initial values b0 to b4 and d0 to d4 may take on the value of the scrambled signal IO, for example. Of course, the initial values b0 to b4 and d0 to d4 are not given at all times but are supplied to the shift registers 100 to 104 and 200 to 204 only when the shift control signal is activated.

In the nature of Gold sequence pseudorandom numbers, even with the same characteristic equation, pseudorandom numbers of a different sequence are generated by changing the initial value. This makes it even more difficult to understand the scrambling method from outside.

[Change of Random Number Generation Sequence]

### Third Preferred Embodiment

FIG. 8 is a circuit diagram of the structure of the key generation unit 214 (see FIG. 1). The key generation unit 214 includes an M-sequence random number generator circuit 214C, and the group of shit registers 130 according to the first preferred embodiment. The M-sequence random number generator circuit 214C includes the group of shift registers 10 according to the first preferred embodiment, and a feedback circuit 123.

The feedback circuit 123 includes operators 105 to 108, and selectors 141 and 142. The operator 105 outputs an exclusive OR of the bit values a0 and a1, the operator 106 outputs an exclusive OR of the output from the selector 141 and the bit value a2, the operator 107 outputs an exclusive OR of the output from the operator 106 and the bit value a3, and the operator 108 outputs an exclusive OR of the output from the operator 107 and the bit value a4.

The selector 141 selects and outputs the bit value a0 or the output from the operator 105 in accordance with a selecting signal sel1 being “0” or “1”. The selector 142 selects and outputs the output from the operator 107 or the output from the operator 108 in accordance with a selecting signal sel2 being “0” or “1”. The shift register 104 receives the output from the selector 142.

Thus the M-sequence random number generator circuit 214C operates based on different characteristic equations depending on the values of the selecting signals sel1 and sel2. More specifically, when the selecting signals sel1 and sel2 select “1” and “0”, respectively, the characteristic equation of the M-sequence random number generator circuit 214C is expressed as F(x)=x⁵+x³+x²+x+1, which is the same as that for the M-sequence random number generator circuit 214A according to the first preferred embodiment. When the selecting signals sel1 and sel2 select “0” and “1”, respectively, the characteristic equation of the M-sequence random number generator circuit 214C is expressed as F(x)=x⁵+x⁴+x³+x²+1.

The selecting signals sel1 and sel2 are output as an activated shift control signal from the shift register control circuit 211. Therefore, the process of generating the scrambling keys is updated with different characteristic equations of M-sequence pseudorandom numbers, thus improving the efficiency of randomness.

### Fourth Preferred Embodiment

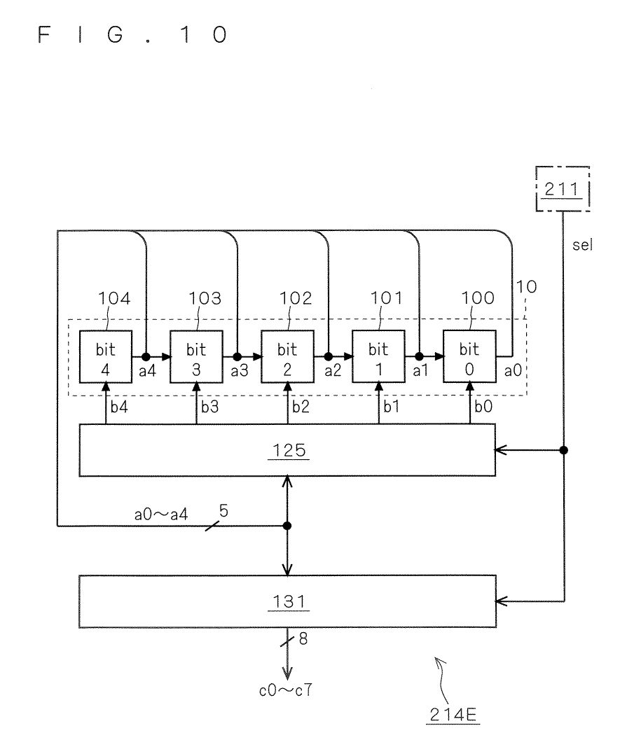

FIG. 9 is a circuit diagram of the structure of the key generation unit 214 (see FIG. 1). The key generation unit 214 includes the M-sequence random number generator circuit 214C according to the third preferred embodiment, the group of shit registers 130 according to the first preferred embodiment, an M-sequence random number generator circuit 214D, and the operator 901 according to the second preferred embodiment. The M-sequence random number generator circuit 214D includes the group of shift registers 20 according to the second preferred embodiment, and a feedback circuit 124.

The feedback circuit 124 includes operators 205 to 208, and selectors 143 and 144. The operator 205 outputs an exclusive OR of the bit values f0 and f1, the operator 206 outputs an exclusive OR of the bit values f1 and f2, the operator 207 outputs an exclusive OR of the output from the selector 143 and the bit value f3, and the operator 208 outputs an exclusive OR of the output from the selector 144 and the bit value f4.

The selector 143 selects and outputs the output from the operator 205 or the output from the operator 206 in accordance with the selecting signal sel1 being “0” or “1”. The selector 144 selects and outputs the output from the selector 143 or the output from the operator 207 in accordance with the selecting signal sel2 being “0” or “1”. The shift register 204 receives the output from the operator 208.

Thus the M-sequence random number generator circuit 214D operates based on different characteristic equations depending on the values of the selecting signals sel1 and sel2. More specifically, when the selecting signals sel1 and sel2 select “1” and “0”, respectively, the characteristic equation of the M-sequence random number generator circuit 214D is expressed as F(x)=x⁵+x⁴+x²+x+1, which is the same as that for the M-sequence random number generator circuit 214B according to the second preferred embodiment. When the selecting signals sel1 and sel2 select “0” and “1”, respectively, the characteristic equation of the M-sequence random number generator circuit 214D is expressed as F(x)=x⁵+x⁴+x³+x+1.

The operator 901 produces and outputs an exclusive OR of the bit values a0 and f0 to the group of shift registers 130.

Thus the key generation unit 214 according to this embodiment functions as a Gold system random number generator circuit. The key generation unit 214 operates based on a characteristic equation of F(x)=(x⁵+x³+x²+x+1)·(x⁵+x⁴+x²+x+1) when the selecting signals sel1 and sel2 select “1” and “0”, respectively, and operates based on a characteristic equation of F(x)=(x⁵+x⁴+x³+x²+1)·(x⁵+ x⁴+x³+ x+1) when the selecting signals sel1 and sel2 select “0” and “1”, respectively.

As mentioned in the third preferred embodiment, the selecting signals sel1 and sel2 are output as an activated shift control signal from the shift register control circuit 211. Therefore, the process of generating the scrambling keys is updated with different characteristic equations of Gold sequence pseudorandom numbers, thus improving the efficiency of randomness.

[Change of the Number of Shift Bits]

### Fifth Preferred Embodiment

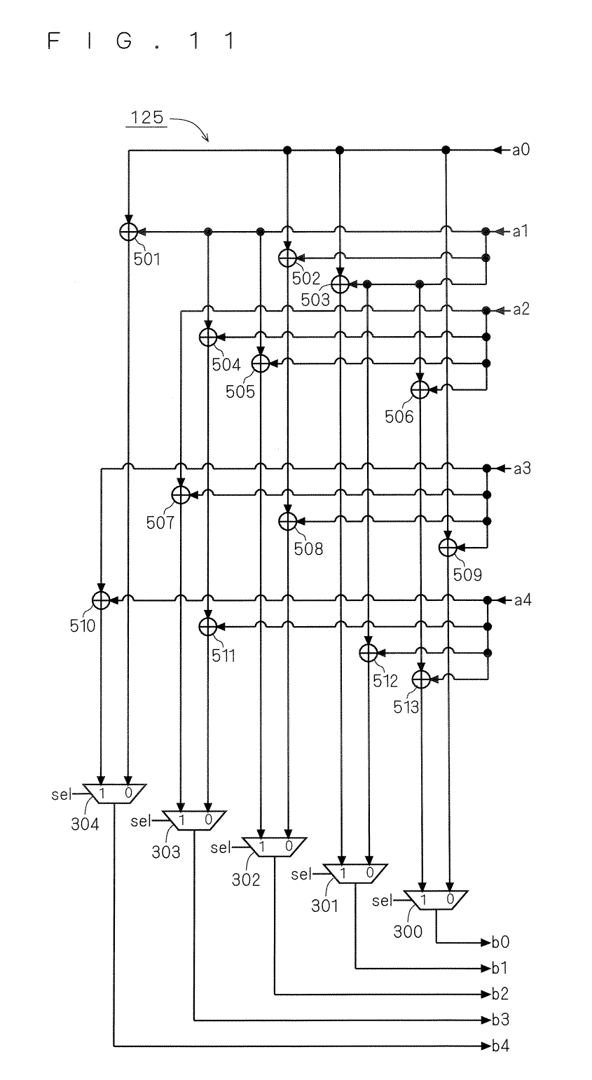

FIG. 10 is a circuit diagram of the structure of the key generation unit 214 (see FIG. 1). The key generation unit 214 is configured as an M-sequence random number generator circuit 214E including the group of shift registers 10 according to the first preferred embodiment, a feedback circuit 125, and an operation circuit 131.

The feedback circuit 125 receives the bit values a0 to a4 from the group of shift registers 10, and generates and supplies the initial values b0 to b4 to the shift registers 100 to 104, respectively. The operation circuit 131 receives the bit values a0 to a4, and outputs values c0 to c7 of 8 bits that become the keys q0 to q7, respectively.

The shift register control circuit 211 outputs a selecting signal sel as an activated shift control signal to the feedback circuit 125 and the operation circuit 131.

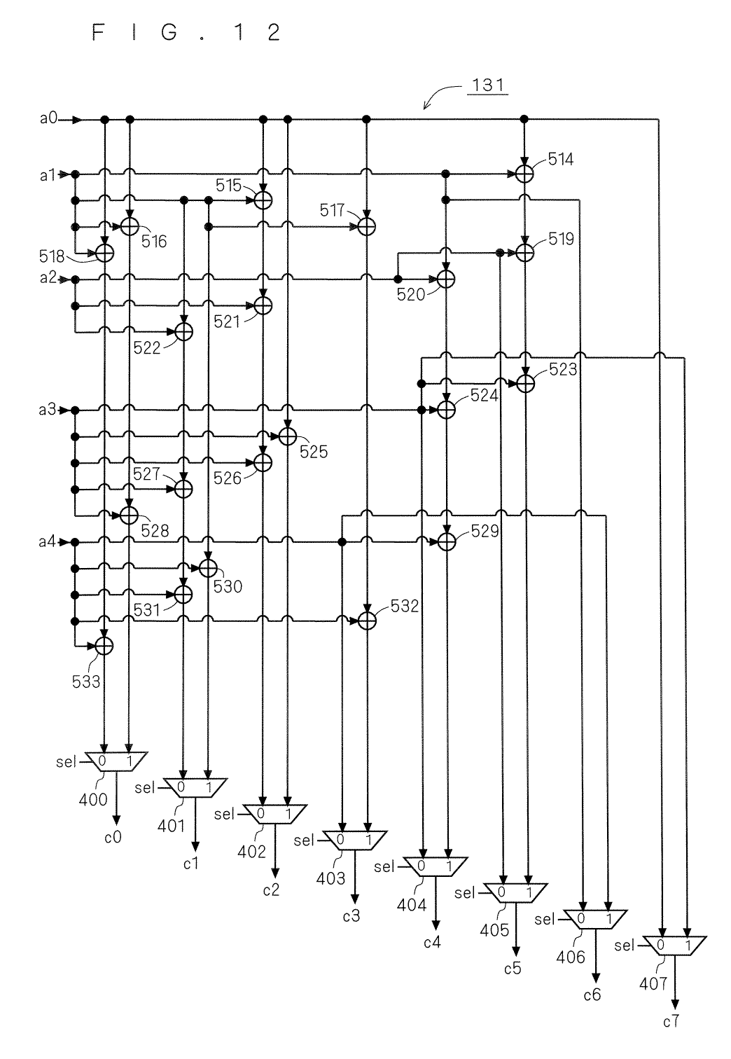

FIG. 11 is a circuit diagram of the structure of the feedback circuit 125. Operators 501, 502 and 503 calculate and output an exclusive OR of the bit values a0 and a1. Operators 504, 505 and 506 calculate and output an exclusive OR of the bit values a1 and a2. An operator 507 calculates and outputs an exclusive OR of the bit values a2 and a3. An operator 508 calculates and outputs an exclusive OR of the bit value a3 and the output from the operator 502. An operator 509 calculates and outputs an exclusive OR of the bit values a0 and a3. An operator 510 calculates and outputs an exclusive OR of the bit values a3 and a4. An operator 511 calculates and outputs an exclusive OR of the bit value a4 and the output from the operator 504. Operators 512 and 530 calculate and output an exclusive OR of the bit values a1 and a4. An operator 513 calculates and outputs an exclusive OR of the bit value a4 and the output from the operator 506.

A selector 300 outputs one of the outputs from the operators 509 and 513 as the initial value b0. More specifically, the selector 300 outputs the output from the operator 509, namely, the exclusive OR of the bit values a0 and a3, when the selecting signal sel selects “0”, and outputs the output from the operator 513, namely, the exclusive OR of the bit values a1, a2 and a4, when the selecting signal sel selects “1”.

A selector 301 outputs one of the outputs from the operators 512 and 503 as the initial value b1. More specifically, the selector 301 outputs the output from the operator 512, namely, the exclusive OR of the bit values a1 and a4, when the selecting signal sel selects “0”, and outputs the output from the operator 503, namely, the exclusive OR of the bit values a0 and a1, when the selecting signal sel selects “1”.

A selector 302 outputs one of the outputs from the operators 508 and 505 as the initial value b2. More specifically, the selector 302 outputs the output from the operator 508, namely, the exclusive OR of the bit values a0, a1 and a3, when the selecting signal sel selects “0”, and outputs the output from the operator 505, namely, the exclusive OR of the bit values a1 and a2, when the selecting signal sel selects “1”.

A selector 303 outputs one of the outputs from the operators 511 and 507 as the initial value b3. More specifically, the selector 303 outputs the output from the operator 511, namely, the exclusive OR of the bit values a1, a2 and a4, when the selecting signal sel selects “0”, and outputs the output from the operator 507, namely, the exclusive OR of the bit values a2 and a3, when the selecting signal sel selects “1”.

A selector 304 outputs one of the outputs from the operators 501 and 510 as the initial value b4. More specifically, the selector 304 outputs the output from the operator 501, namely, the exclusive OR of the bit values a0 and a1, when the selecting signal sel selects “0”, and outputs the output from the operator 510, namely, the exclusive OR of the bit values a3 and a4, when the selecting signal sel selects “1”.

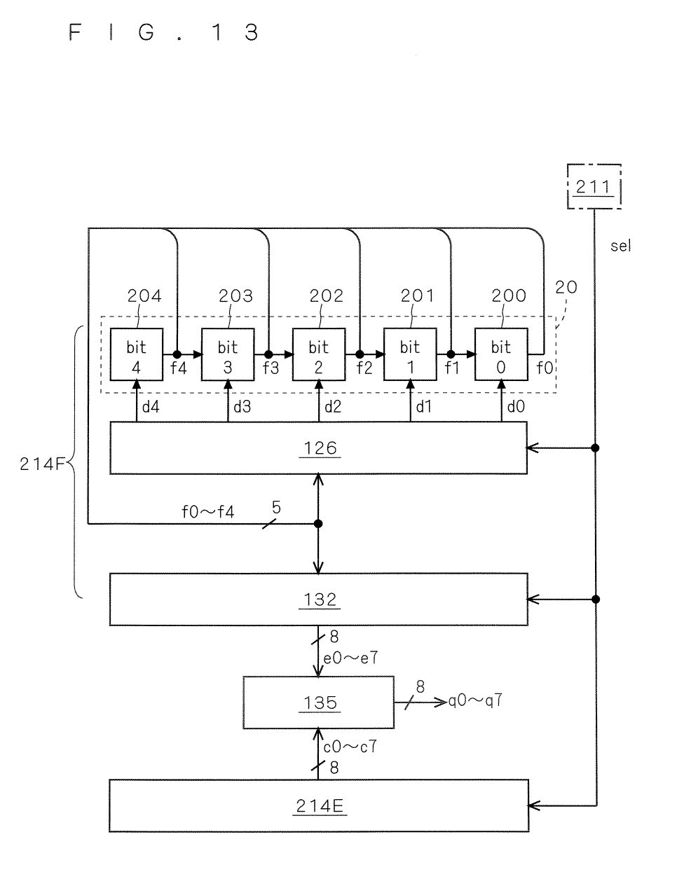

FIG. 12 is a circuit diagram of the structure of the operation circuit 131. Operators 514, 515, 516, 517 and 518 calculate and output an exclusive OR of the bit values a0 and a1. An operator 519 calculates and outputs an exclusive OR of the bit value a2 and the output from the operator 514. Operators 520 and 522 calculate and output an exclusive OR of the bit values a1 and a2. An operator 521 calculates and outputs an exclusive OR of the bit value a2 and the output from the operator 515. An operator 523 calculates and outputs an exclusive OR of the bit value a3 and the output from the operator 519. An operator 524 calculates and outputs an exclusive OR of the bit value a3 and the output from the operator 520. An operator 525 calculates and outputs an exclusive OR of the bit values a0 and a3. An operator 526 calculates and outputs an exclusive OR of the bit value a3 and the output from the operator 521. An operator 527 calculates and outputs an exclusive OR of the bit value a3 and the output from the operator 522. An operator 528 calculates and outputs an exclusive OR of the bit value a3 and the output from the operator 516. An operator 529 calculates and outputs an exclusive OR of the bit value a4 and the output from the operator 524. An operator 531 calculates and outputs an exclusive OR of the bit value a4 and the output from the operator 527. An operator 532 calculates and outputs an exclusive OR of the bit value a4 and the output from the operator 517. An operator 533 calculates and outputs an exclusive OR of the bit value a4 and the output from the operator 518.

The M-sequence random number generator circuit 214E having this structure generates M-sequence pseudorandom numbers based on the characteristic equation of F(x)=x⁵+x³+x²+x+1. When the selecting signal sel selects “0”, the initial values b0 to b4 are the exclusive OR of the bit values a0 and a3, the exclusive OR of the bit values a1 and a4, the exclusive OR of the bit values a0, a1 and a3, the exclusive OR of the bit values a1, a2 and a4, and the exclusive OR of the bit values a0 and a1, respectively. These values correspond to values obtained by shifting the M-sequence pseudorandom numbers based on the characteristic equation of F(x)=x⁵+x³+x²+x+1 by 8 bits for the shift registers 100 to 104. That is, when the selecting signal sel selects “0”, M-sequence pseudorandom numbers having the number of shift bits of 8 are generated.

When the selecting signal sel selects “0”, the 8-bit values c0 to c7 are an exclusive OR of the bit values a0, a1 and a4, an exclusive OR of the bit values a1, a2, a3 and a4, an exclusive OR of the bit values a0, a1, a2 and a3, the bit value a4, the bit value a3, the bit value a2, the bit value a1, and the bit value a0, respectively.

When the selecting signal sel selects “1”, the initial values b0 to b4 are the exclusive OR of the bit values a1, a2 and a4, the exclusive OR of the bit values a0 and a1, the exclusive OR of the bit values a1 and a2, the exclusive OR of the bit values a2 and a3, and an exclusive OR of the bit values a3 and a4, respectively. These values correspond to values obtained by shifting the M-sequence pseudorandom numbers based on the characteristic equation of F(x)=x⁵+x³+x²+x+1 by 11 bits for the shift registers 100 to 104. That is, when the selecting signal sel selects “1”, M-sequence pseudorandom numbers having the number of shift bits of 11 are generated.

When the selecting signal sel selects “1”, the 8-bit values c0 to c7 are the exclusive OR of the bit values a0, a1 and a3, the exclusive OR of the bit values a1 and a4, the exclusive OR of the bit values a0 and a3, the exclusive OR of the bit values a0, a1 and a4, the exclusive OR of the bit values a1, a2, a3 and a4, the exclusive OR of the bit values a0, a1, a2 and a3, the bit value a4, and the bit value a3, respectively.

The selecting signal sel is output as an activated shift control signal from the shift register control circuit 211. Therefore, the process of generating the scrambling keys is updated with different numbers of shift bits of M-sequence pseudorandom numbers, thus improving the efficiency of randomness.

It is preferable that the number of shift bits be relatively prime to a period of the M-sequence pseudorandom numbers. This is because the efficiency of randomness will be spoiled when they have a common divisor other than 1.

### Sixth Preferred Embodiment

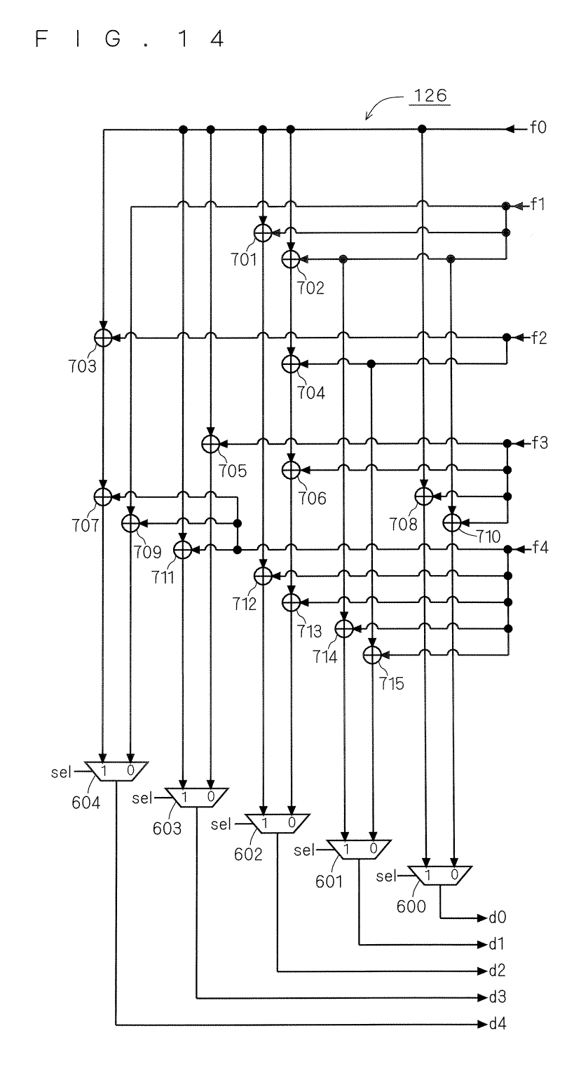

FIG. 13 is a circuit diagram of the structure of the key generation unit 214 (see FIG. 1). The key generation unit 214 includes the M-sequence random number generator circuit 214E according to the fifth preferred embodiment, an M-sequence random number generator circuit 214F, and a composition unit 135. The M-sequence random number generator circuit 214F includes the group of shift registers 20 according to the second preferred embodiment, a feedback circuit 126, and an operation circuit 132.

The shift register control circuit 211 outputs the selecting signal sel as an activated shift control signal to the M-sequence random number generator circuit 214E, the feedback circuit 126 and the operation circuit 132. The operation of the M-sequence random number generator circuit 214E was described in the fifth preferred embodiment, and a discussion of the operation is not replicated below. Note that in this embodiment, the 8-bit values c0 to c7 function as output precursory values for obtaining the keys q0 to q7.

The feedback circuit 126 receives the bit values f0 to f4 from the group of shift registers 20, and generates and supplies the initial values d0 to d4 to the shift registers 200 to 204, respectively. The operation circuit 132 receives the bit values f0 to f4, and outputs output precursory values e0 to e7 of 8 bits.

The composition unit 135 produces an exclusive OR for each bit of the output precursory values c0 to c7 and e0 to e7, and outputs the exclusive ORs as the keys q0 to q7. Namely, the M-sequence random number generator circuits 214E and 214F according to this embodiment generate two pairs of output precursory values instead of the keys q0 to q7. Then the exclusive ORs of the two pairs of output precursory values are produced, thereby generating keys for scrambling/descrambling.

Put another way, the fifth preferred embodiment can be understood as a variant of this embodiment with the assumption that all the output precursory values e0 to e7 are zero.

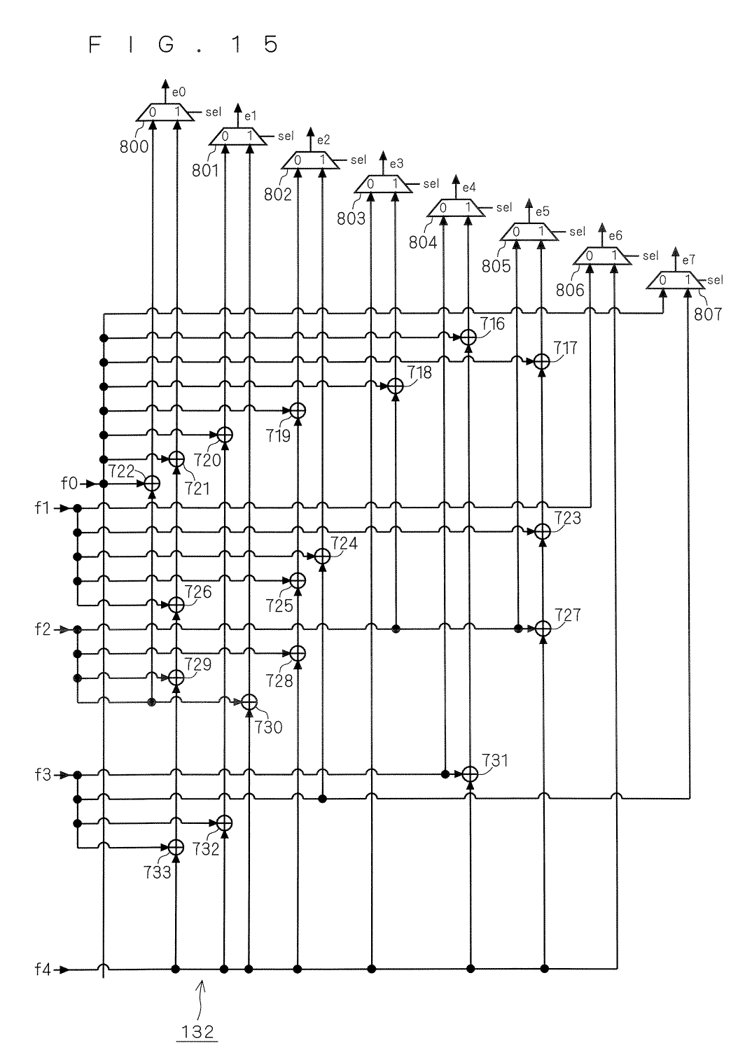

FIG. 14 is a circuit diagram of the structure of the feedback circuit 126. Operators 701 and 702 calculate and output an exclusive OR of the bit values f0 and f1. An operator 703 calculates and outputs an exclusive OR of the bit values f0 and f2. An operator 704 calculates and outputs an exclusive OR of the bit value f2 and the output from the operator 702. An operator 705 calculates and outputs an exclusive OR of the bit values f0 and f3. An operator 706 calculates and outputs an exclusive OR of the bit value f3 and the output from the operator 704. An operator 707 calculates and outputs an exclusive OR of the bit value f4 and the output from the operator 703. An operator 708 calculates and outputs an exclusive OR of the bit values f0 and f3. Operators 709 and 714 calculate and output an exclusive OR of the bit values f1 and f4. An operator 710 calculates and outputs an exclusive OR of the bit values f1 and f3. An operator 711 calculates and outputs an exclusive OR of the bit values f0 and f4. An operator 712 calculates and outputs an exclusive OR of the bit value f4 and the output from the operator 701. An operator 713 calculates and outputs an exclusive OR of the bit value f4 and the output from the operator 706. An operator 715 calculates and outputs an exclusive OR of the bit values f2 and f4.

A selector 600 outputs one of the outputs from the operators 710 and 708 as the shift register setting value d0. More specifically, the selector 600 outputs the output from the operator 710, namely, the exclusive OR of the bit values f1 and f3, when the selecting signal sel selects “0”, and outputs the output from the operator 708, namely, the exclusive OR of the bit values f0 and f3, when the selecting signal sel selects “1”.

A selector 601 outputs one of the outputs from the operators 715 and 714 as the shift register setting value d1. More specifically, the selector 601 outputs the output from the operator 715, namely, the exclusive OR of the bit values f2 and f4, when the selecting signal sel selects “0”, and outputs the output from the operator 714, namely, the exclusive OR of the bit values f1 and f4, when the selecting signal sel selects “1”.

A selector 602 outputs one of the outputs from the operators 713 and 712 as the shift register setting value d2. More specifically, the selector 602 outputs the output from the operator 713, namely, the exclusive OR of the bit values f0, f1, f2, f3 and f4, when the selecting signal sel selects “0”, and outputs the output from the operator 712, namely, the exclusive OR of the bit values f1, f1 and f4, when the selecting signal sel selects “1”.

A selector 603 outputs one of the outputs from the operators 705 and 711 as the shift register setting value d3. More specifically, the selector 603 outputs the output from the operator 705, namely, the exclusive OR of the bit values f0 and f3, when the selecting signal sel selects “0”, and outputs the output from the operator 711, namely, the exclusive OR of the bit values f0 and f4, when the selecting signal sel selects “1”.

A selector 604 outputs one of the outputs from the operators 709 and 707 as the shift register setting value d4. More specifically, the selector 604 outputs the output from the operator 709, namely, the exclusive OR of the bit values f1 and f4, when the selecting signal sel selects “0”, and outputs the output from the operator 707, namely, the exclusive OR of the bit values f0, f2 and f4, when the selecting signal sel selects “1”.

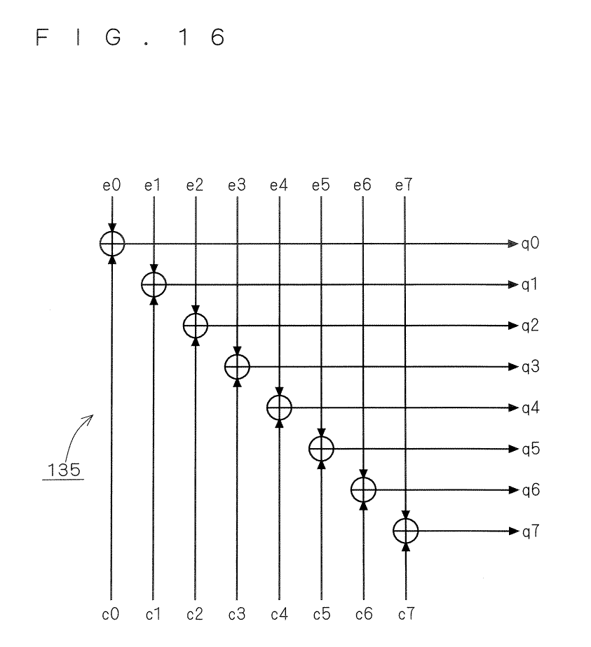

FIG. 15 is a circuit diagram of the structure of the operation circuit 132. An operator 716 calculates and outputs an exclusive OR of the bit value f0 and the output from the operator 731. An operator 717 calculates and outputs an exclusive OR of the bit value f0 and the output from the operator 723. Operators 718 and 722 calculate and output an exclusive OR of the bit values f0 and f2. An operator 719 calculates and outputs an exclusive OR of the bit value f0 and the output from the operator 725. An operator 720 calculates and outputs an exclusive OR of the bit value f0 and the output from the operator 732. An operator 721 calculates and outputs an exclusive OR of the bit value f0 and the output from the operator 726. An operator 723 calculates and outputs an exclusive OR of the bit value f1 and the output from the operator 727. An operator 724 calculates and outputs an exclusive OR of the bit values f1 and f3. An operator 725 calculates and outputs an exclusive OR of the bit value f1 and the output from the operator 728. An operator 726 calculates and outputs an exclusive OR of the bit value f1 and the output from the operator 729. Operators 727, 728 and 730 calculate and output an exclusive OR of the bit values f2 and f4. An operator 729 calculates and outputs an exclusive OR of the bit value f2 and the output from the operator 733. Operators 731, 732 and 733 calculate and output an exclusive OR of the bit values f3 and f4.

A selector 800 outputs one of the outputs from the operators 722 and 721 as the output precursory value e0. More specifically, the selector 800 outputs the output from the operator 722, namely, the exclusive OR of the bit values f0 and f2, when the selecting signal sel selects “0”, and outputs the output from the operator 721, namely, the exclusive OR of the bit values f0, f1, f2, f3 and f4, when the selecting signal sel selects “1”.

A selector 801 outputs one of the outputs from the operators 720 and 730 as the output precursory value e1. More specifically, the selector 801 outputs the output from the operator 720, namely, the exclusive OR of the bit values f0, f3 and f4, when the selecting signal sel selects “0”, and outputs the output from the operator 730, namely, the exclusive OR of the bit values f2 and f4, when the selecting signal sel selects “1”.

A selector 802 outputs one of the outputs from the operators 719 and 724 as the output precursory value e2. More specifically, the selector 802 outputs the output from the operator 719, namely, the exclusive OR of the bit values f0, f1, f2 and f4, when the selecting signal sel selects “0”, and outputs the output from the operator 724, namely, the exclusive OR of the bit values f1 and f3, when the selecting signal sel selects “1”.

A selector 803 outputs one of the outputs from the bit value f4 and the operator 718 as the output precursory value e3. More specifically, the selector 803 outputs a value stored in the bit value f4 when the selecting signal sel selects “0”, and outputs the output from the operator 718, namely, the exclusive OR of the bit values f0 and f2, when the selecting signal sel selects “1”.

A selector 804 outputs one of the outputs from the bit value f3 and the operator 731 as the output precursory value e4. More specifically, the selector 804 outputs a value stored in the bit value f3 when the selecting signal sel selects “0”, and outputs the output from the operator 731, namely, the exclusive OR of the bit values f0, f3 and f4, when the selecting signal sel selects “1”.

A selector 805 outputs one of the outputs from the bit value f2 and the operator 717 as the output precursory value e5. More specifically, the selector 805 outputs a value stored in the bit value f2 when the selecting signal sel selects “0”, and outputs the output from the operator 717, namely, the exclusive OR of the bit values f0, f1, f2 and f4, when the selecting signal sel selects “1”.

A selector 806 outputs a value stored in the bit value f1 when the selecting signal sel selects “0”, and outputs a value stored in the bit value f4 when the selecting signal sel selects “1”, respectively, as the output precursory value e6.

A selector 807 outputs a value stored in the bit value f0 when the selecting signal sel selects “0”, and outputs a value stored in the bit value f3 when the selecting signal sel selects “1”, respectively, as the output precursory value e7.

The M-sequence random number generator circuit 214F having this structure generates M-sequence pseudorandom numbers based on the characteristic equation of F(x)=x⁵+x⁴+x²+x+1. When the selecting signal sel selects “0”, the initial values d0 to d4 are an exclusive OR of the bit values f1 and f3, an exclusive OR of the bit values f2 and f4, an exclusive OR of the bit values f0, f1, f2, f3 and f4, an exclusive OR of the bit values f0 and f2, and an exclusive OR of the bit values f1 and f4, respectively.

These values correspond to values obtained by shifting the M-sequence pseudorandom numbers based on the characteristic equation of F(x)=x⁵+x⁴+x²+x+1 by 8 bits for the shift registers 200 to 204. That is, when the selecting signal sel selects “0”, M-sequence pseudorandom numbers having the number of shift bits of 8 are generated.

When the selecting signal sel selects “0”, the output precursory values e0 to e7 are an exclusive OR of the bit values f0 and f2, an exclusive OR of the bit values f0, f3 and f4, an exclusive OR of the bit values f0, f1, f2 and f4, the bit value f4, the bit value f3, the bit value f2, the bit value f1, and the bit value f0, respectively.

When the selecting signal sel selects “1”, the initial values d0 to d4 are an exclusive OR of the bit values f0 and f3, an exclusive OR of the bit values f1 and f4, an exclusive OR of the bit values f0, f1 and f4, an exclusive OR of the bit values f0 and f4, and an exclusive OR of the bit values f0, f2 and f4, respectively.

These values correspond to values obtained by shifting the M-sequence pseudorandom numbers based on the characteristic equation of F(x)=x⁵+x⁴+x²+x+1 by 11 bits for the shift registers 200 to 204. That is, when the selecting signal sel selects “1”, M-sequence pseudorandom numbers having the number of shift bits of 11 are generated.

When the selecting signal sel selects “1”, the output precursory values e0 to e7 are an exclusive OR of the bit values f0, f1, f2, f3 and f4, an exclusive OR of the bit values f2 and f4, an exclusive OR of the bit values f1 and f3, an exclusive OR of the bit values f0 and f2, an exclusive OR of the bit values f0, f3 and f4, an exclusive OR of the bit values f0, f1, f2 and f4, the bit value f4, and the bit value f3, respectively.

FIG. 16 is a circuit diagram of the structure of the composition unit 135. The composition unit 135 includes eight operators, each of which calculates an exclusive OR of a pair of one bits. These eight operators produce an exclusive OR for each bit of the output precursory values c0 to c7 and e0 to e7, and output the exclusive ORs as the keys q0 to q7.

Thus the key generation unit 214 according to this embodiment functions as a Gold system random number generator circuit which operates based on a characteristic equation of F(x)=(x⁵+x³+x²+x+1)·(x⁵+x⁴+x²+x+1). As the number of shift bits, 8 bits or 11 bits are employed in accordance with the selecting signal being “0” or “1”, respectively.

The selecting signal sel is output as an activated shift control signal from the shift register control circuit 211. Therefore, the process of generating the scrambling keys is updated with different numbers of shift bits of Gold sequence pseudorandom numbers, thus improving the efficiency of randomness.

[Variant]

Although the techniques of producing pseudorandom numbers using an M-sequence and Gold sequence have been described in the above descriptions, the random numbers employed in this invention may be produced by other methods. Other methods of producing pseudorandom numbers may be employed to prepare a plurality of criteria for determining the timing of updating the method of generating the scrambling keys mentioned in the [Basic Concept] section.

While the invention has been shown and described in detail, the foregoing description is in all aspects illustrative and not restrictive. It is therefore understood that numerous modifications and variations can be devised without departing from the scope of the invention.

What is claimed is:

1. A semiconductor memory comprising:
a memory array; and
a scramble/descramble unit generating output data by scrambling read data read from said memory array, generating a command for said memory array by descrambling a received scrambled signal, and updating a method of generating a key used for said scrambling and/or descrambling upon satisfaction of a prescribed condition by at least one selected between at least two out of said scrambled signal, said command, said read data, and said output data.

2. The semiconductor memory according to claim 1, wherein said scramble/descramble unit comprises
a control circuit generating a control signal for updating said method of generating said key, and
a selector supplying said read data and said scrambled signal selectively to said control circuit.

3. A semiconductor memory comprising:
a memory array; and
a scramble/descramble unit generating output data by scrambling read data read from said memory array, generating a command for said memory array by descrambling a received scrambled signal, and updating a method of generating a key used for said scrambling and/or descrambling upon satisfaction of a prescribed condition by at least one selected between said scrambled signal and said output data.

4. The semiconductor memory according to claim 3, wherein said scramble/descramble unit comprises a control circuit, said control circuit receiving said scrambled signal and said output data and generating a control signal for updating said method of generating said key upon satisfaction of said prescribed condition by at least one of said scrambled signal and said output data.

5. The semiconductor memory according to claim 2, wherein said scramble/descramble unit comprises an operation unit calculating an exclusive OR of said scrambled signal or said read data and said key.

6. The semiconductor memory according to claim 4, wherein said scramble/descramble unit comprises an operation unit calculating an exclusive OR of said scrambled signal or said read data and said key.

7. The semiconductor memory according to claim 1, wherein
said key is a maximum length sequence pseudorandom number, and
said update is to update an initial value of said maximum length sequence pseudorandom number.

8. The semiconductor memory according to claim 3, wherein
said key is a maximum length sequence pseudorandom number, and
said update is to update an initial value of said maximum length sequence pseudorandom number.

9. The semiconductor memory according to claim 1, wherein
said key is a Gold sequence pseudorandom number, and
said update is to update an initial value of said Gold sequence pseudorandom number.

10. The semiconductor memory according to claim 3, wherein
said key is a Gold sequence pseudorandom number, and
said update is to update an initial value of said Gold sequence pseudorandom number.

11. The semiconductor memory according to claim 1, wherein
said key is a maximum length sequence pseudorandom number, and
said update is to update an initial value of said maximum length sequence pseudorandom number.

12. The semiconductor memory according to claim 3, wherein
said key is a maximum length sequence pseudorandom number, and
said update is to update an initial value of said maximum length sequence pseudorandom number.

13. The semiconductor memory according to claim 1, wherein
said key is a Gold sequence pseudorandom number, and
said update is to update a characteristic equation of said Gold sequence pseudorandom number.

14. The semiconductor memory according to claim 3, wherein
said key is a Gold sequence pseudorandom number, and
said update is to update a characteristic equation of said Gold sequence pseudorandom number.

15. The semiconductor memory according to claim 1, wherein
said key is a maximum length sequence pseudorandom number, and
said update is to update an initial value of said maximum length sequence pseudorandom number.

16. The semiconductor memory according to claim 3, wherein
said key is a maximum length sequence pseudorandom number, and
said update is to update an initial value of said maximum length sequence pseudorandom number.

17. The semiconductor memory according to claim 1, wherein
said key is a Gold sequence pseudorandom number, and
said update is to update the number of shift bits of said Gold sequence pseudorandom number.

18. The semiconductor memory according to claim 3, wherein
said key is a Gold sequence pseudorandom number, and
said update is to update the number of shift bits of said Gold sequence pseudorandom number.

19. A data transfer system comprising:
the semiconductor memory according to claim 1; and
a host device, said host device comprising a scramble/descramble unit scrambling and/or descrambling using said key.

20. A data transfer system comprising:
the semiconductor memory according to claim 3; and
a host device, said host device comprising a scramble/descramble unit scrambling and/or descrambling using said key.
